(19) United States
(12) Patent Application Publication
(10) Pub. No.: US 2002/0194739 A1
(43) Pub. Date: Dec. 26, 2002

(54) Manually guided implement

(75) Inventors: Florian V. Krane, Remshalden (DE); Thomas Stark, Waiblingen (DE)

Correspondence Address: ROBERT W. BECKER & ASSOCIATES, Suite B, 707 Highway 66 East, Tijeras, NM, 87059, US

(73) Assignee: Andreas Stihl AG & Co.

(21) Appl. No.: 10/165,784

(22) Filed: Jun. 7, 2002

(30) Foreign Application Priority Data
Jun. 21, 2001 (DE) 201 10 321.4

(51) Int. Cl. B23D 59/00

(52) U.S. Cl. 30/296.1; 30/381; 30/383

(57) ABSTRACT

A manually guided implement, such as a pole pruner, is provided. Disposed at one end of a supporting tube is a drive motor that via a shaft disposed in the supporting tube drives a working tool that is held at the other end of the supporting tube. The supporting tube has a section that is associated with the working tool, and a section that is associated with the drive unit. The sections of the supporting tube are fixedly interconnected via a gearbox of a miter gear, with the angle being prescribed by the gearbox and being less than or greater than 180°.

### BACKGROUND OF THE INVENTION

The present invention relates to a manually guided implement, especially a pole pruner, a brush-cutter, a long-reach hedge trimmer, or the like.

U.S. Pat. No. 4,122,601 discloses a manually guided implement that at one end of a supporting tube is provided with a drive motor that drives a working tool that is held at the other end of the supporting tube. The supporting tube is divided into longitudinal sections in order to be able to transport the implement in a compact form. The two sections of the supporting tube can be fixedly connected to one another with the aid of coupling elements that in the assembled state of the implement are disposed at respectively facing ends of the supporting tube. The working tool assumes a fixed angle relative to the supporting tube.

Unfortunately, with the known manually guided implement it is not possible to adjust the working position nor the working tool in a manner specific to a particular application.

It is therefore an object of the present invention to provide a manually guided implement that with a straightforward and economical construction makes it possible to adjust the working position of the working tool in a manner specific to the application at hand.

### BRIEF DESCRIPTION OF THE DRAWINGS

This object, and other objects and advantages of the present invention, will appear more clearly from the following specification in conjunction with the accompanying schematic drawings, in which:

FIG. 1 is a perspective view of one exemplary embodiment of an inventive manually guided implement;

FIG. 2 is a perspective view of a miter gear on the supporting tube of the manually guided implement of FIG. 1;

FIG. 3 is a longitudinal cross-sectional view through the miter gear of FIG. 2;

FIG. 4 is a perspective view of a working tool of a pole pruner;

FIG. 5 is a view of the working tool of FIG. 4 in a different working position;

FIG. 6 is a view of the working tool of FIG. 5 in a different working position;

### SUMMARY OF THE INVENTION

The manually guided implement of the present invention is characterized primarily in that the sections of the supporting tube are fixedly interconnected via a gearbox of a miter gear at an angle that is prescribed by the gearbox and is smaller or greater than 180°.

Due to the fact that the sections of the supporting tube can be rigidly interconnected by a gearbox of a miter gear at a fixed angle that is prescribed by the shape of the gearbox, and that is other than 180°, various angles of inclination or adjustment angles of the working tool relative to the supporting tube can be selected in a simple manner. In this way, different working positions of the tool and of the manually guided implement can be set and maintained.

Pursuant to a preferred embodiment of the present invention, at least one end, and in particular both ends, of the supporting tube sections that face the gearbox, are respectively in engagement with a shaft on the gearbox. In this connection, the shaft can either extend into the gearbox or can project from the contour thereof. In this connection, it is expedient to monolithically embody the shafts with the gearbox. Depending upon the shape of the gearbox, especially as a function of the angular arrangement of the shafts relative to one another on the gearbox, the angle between the supporting tube sections is fixed. The miter gear is preferably surrounded by a spherical gearbox. It is expedient to form the gearbox from two housing portions that are symmetrical relative to one another. In this connection, the gearbox is expediently divided along a centerline of the gearbox.

The shaft as well as the supporting tube are divided, whereby bevel gears are disposed on those shaft ends that face the gearbox; the bevel gears connect the shaft sections with one another in a torque transferring manner. In this connection, the shaft ends are held and guided in the shafts of the gearbox with one or more bearing means, preferably double rowed, grooved ball bearings. All known types of miter gears, for example bevel gearings or cogwheel gearings, can be used, whereby it is expedient to differentiate the speeds of the two shaft sections relative to one another. A ratio of 1.9 to 2.1, transferred into slow or fast, has been shown to be advantageous when working with a pole pruner. In this connection, a pole pruner has a saw chain to that circulates about a guide bar, or has an oscillating saw blade, and serves for the removal of branches or underbrush from locations in trees or bushes that could otherwise be reached only with the aid of auxiliary means.

Pursuant to one preferred embodiment of the inventive manually guided implement, the shaft ends of the shaft sections are fixedly and axially removably connected with respective hubs in the gearbox. The hubs are held and guided in the gearbox or in the shafts via a bearing means. It could also be expedient to monolithically form the hubs with a respective bevel gear.

For the positive and/or frictional clamping connection of the supporting tube sections with the gearbox, each shaft is provided with one or more elongated slots and with a clamping device. The supporting tube sections are thereby releasably and rotatably held in the shafts. As a consequence of the structural features, the coordination of the supporting tube sections relative to the shafts, in other words to the drive and driven sides of the gearbox, can be varied. As a result, the speed ratio can be adjusted to slow or fast by means of a simple interchange.

It is expedient to embody the housing portions as castings, die cast parts, or injection molded parts, and to screw or bolt them to one another. With a pole pruner, it has been shown that the angle of the supporting tube sections, especially their longitudinal axes, relative to one another is advantageously approximately 150°.

Further specific features of the present invention will be described in detail subsequently.

### DESCRIPTION OF PREFERRED EMBODIMENTS

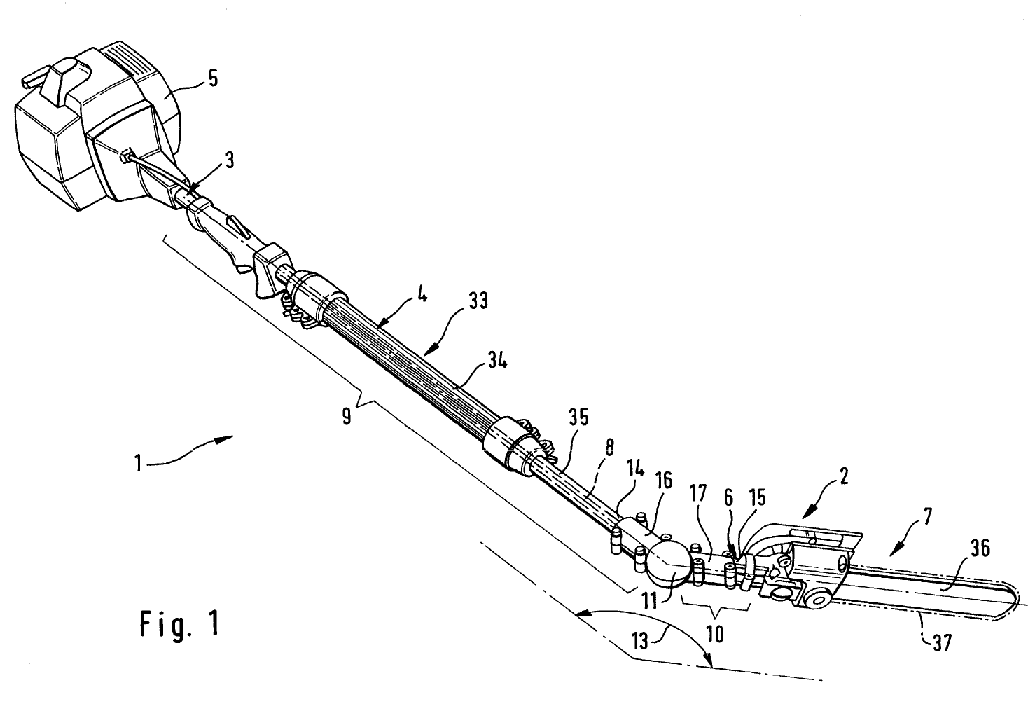

Referring now to the drawings in detail, the manually-guided implement 1 illustrated in FIG. 1 serves for the removal of branches, trees or the like, and is also designated as a pole pruner 2. The implement 1 comprises a supporting tube 4, on one end 3 of which is fixed a drive motor 5, and on the other end 6 of which is fixed a working tool 7. In the illustrated embodiment, the supporting tube 4 is formed as a telescopic rod 33, and comprises an outer tube 34 and an inner tube 35 that is longitudinally displaceable within the outer tube. The working tool 7 is driven with the aid of a shaft 8 that extends in the supporting tube 4 and connects the drive motor 5 and the tool 7. In this connection, the working tool 7 is essentially formed of a guide bar 36 about the periphery of which circulates a saw chain 37.

The supporting tube 4 is composed of a first section 9 that is associated with the drive means 5, and a second section 10 that is associated with the tool 7; the sections 9,10 are fixedly interconnected by a gearbox 11 of a miter gear 12 so that they do not bend or rotate relative to one another. In this connection, the sections 9 and 10 of the supporting tube 4 are rigidly interconnected at an angle 13 of about 150°. In the illustrated embodiment, the axial ends 14,15 of the supporting tube sections 9,10, which ends are remote from the drive motor 5 and the working tool 7 respectively, extend into cylindrical shafts 16,17 on the gearbox 11. It can also be expedient to embody one of the two supporting tube sections 9,10 monolithically, for example as a casting, with a gearbox 11. In the embodiment illustrated in FIGS. 1 to 6, the shafts 16,17 are monolithically formed with the spherical gearbox 11.

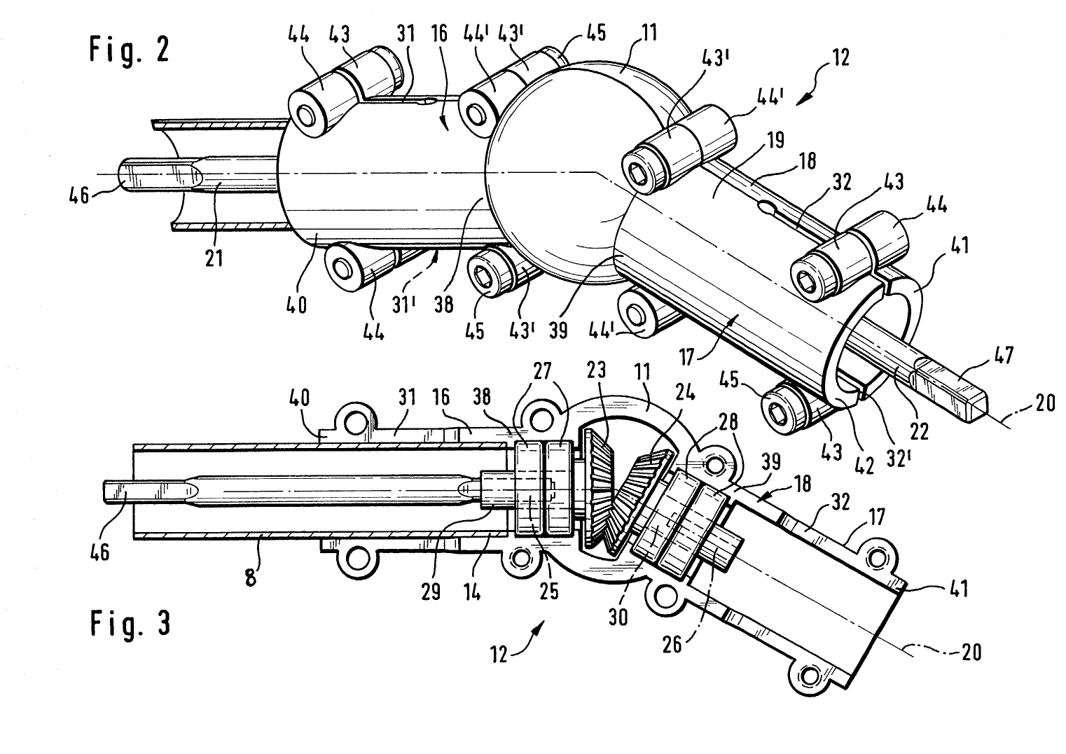

To simplify the manufacture of the gearbox with the shafts, in the embodiment illustrated in FIGS. 1 to 6 the gearbox 11 and the shafts 16,17 are formed of two housing portions 18,19 that have the same shape and that are symmetrical relative to one another along a centerline 20 of the housing (see FIGS. 2 and 3). The shaft 8 between the drive motor and the working tool is interrupted in the gearbox 11, especially in the region of the respective shaft bases 38,39 at the gearbox. In the embodiment shown in FIGS. 2 and 3, the shaft 8 ends in the region of the respective axial ends 40 and 41 of the shafts 16 and 17 that face away from the gearbox 11. Not only on the shaft ends 25,26 that face the gearbox 11, but also on the shaft ends 46 and 47 in the region of the axial ends 40 and 41, the shaft sections 21,22 have a polygonal portion, in the illustrated embodiment a square end. Disposed in the gearbox 11, on the shaft ends 25,26, are bevel gears 23,24 that are fixedly connected with the shaft ends and the axes of which intersect in the interior of the gearbox 11. A flexible shaft, a universal coupling or the like can also be provided. The bevel gears 23,24 are monolithically formed with hubs 29,30 that extend axially from the interior of the gearbox 11 into the respective shaft base 38, 39 of the shafts 16,17. Each of the hubs 29,30 extends through a bearing means 27,28, whereby in the illustrated embodiment the bearing means 27,28 are embodied as double rowed, grooved ball bearings. The grooved ball bearings are supported against the inner wall of the shaft bases 38,39. In this way, a miter gear 12 is formed that can be inserted in a modular fashion between the carrying tube sections 9 and 10. The speed of the shaft sections 21, 22 is differentiated by the miter gear 12, and in the illustrated embodiment is transmitted in the ratio of 1.9 to 2.1.

As can be seen in FIG. 2, each shaft 16,17 has at least one elongated slot 31,32. In the illustrated embodiment, each shaft 16,17 is respectively provided with an elongated slot 31,31′ and an elongated slot 32,32′ that are disposed across from one another on the shafts. The elongated slots extend axially approximately from the ends 40,41 over half of the axial length of the respective shaft 16,17, and extend through the wall 42 thereof. For the mutual screwing or bolting together of the housing portions 18,19, in the region of the axial ends 40,41 of the shafts 16,17, and in the region of the shaft bases 38,39, cylindrical socket-shaped mounting means, 43,43′ and 44,44′, which extend tangentially relative to the wall 42 and transverse to the centerline 20 of the housing, are monolithically formed on the respective housing portions 18,19. In this connection, in the axial direction, the mounting means 43,43′ and 44,44′ are disposed across from one another and in alignment on the housing portions 18,19. The mounting means 43,43′ and 44,44′ serve for the positive and/or frictional receipt of securing elements. In the embodiment illustrated in FIGS. 1 to 6, the securing elements are embodied as screws or bolts, especially cylindrical bolts, that extend through the mounting means 43,43′ and have threads that engage the mounting means 44,44′. This results in a detachable clamping connection between the shafts 16,17 and the ends 14,15 of the supporting tube sections 9,10 when the supporting tube sections appropriately extend into the shafts. As a function of the exchangeable arrangement of the supporting tube sections 9,10 relative to the shafts 16,17—an installation position of the miter gear 12 rotated by 180°—the speed ratio of the miter gear can thereby be defined from slow to fast or from fast to slow.

For an economical manufacture of the gearbox 11, the latter is formed as a casting, a die cast part, or as an injection molding of lightweight metal or thermoplastic polymeric material, especially fiber-reinforced thermoplastic material. Instead of the illustrated clamping connection, it is also possible to use holding clamps that span the shaft ends 40,41.

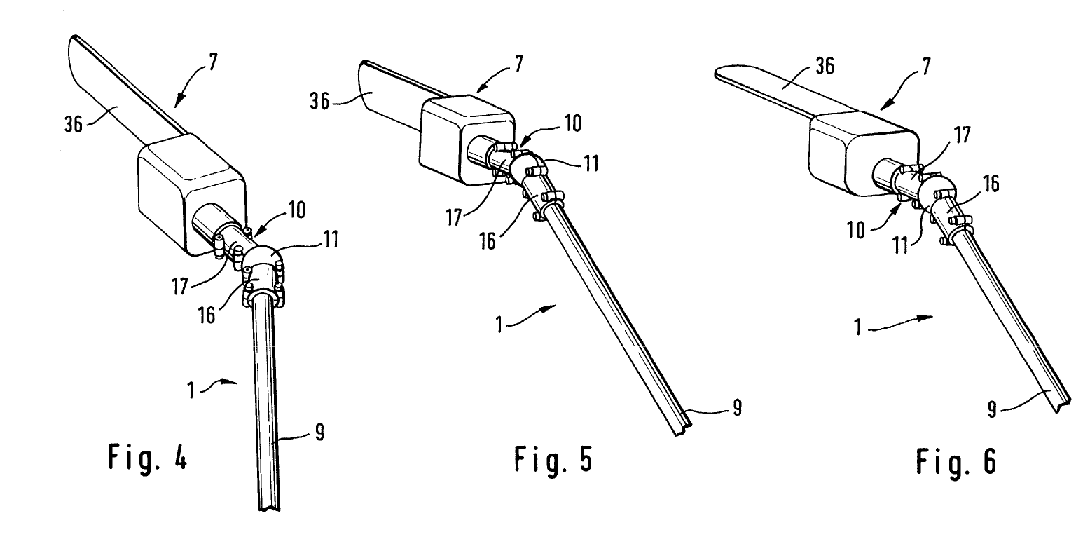

FIGS. 4 to 6 show, by way of example only, various possible positions of the working tool 7 relative to the supporting tube section 9. In contrast to a starting position shown in FIG. 4, in FIG. 5 the working tool 7, together with the gearbox 11, are rotated about the supporting tube section 9 that is on the motor side. For this purpose, the clamping connection between the supporting tube section 9 and the shaft 16 is loosened or released, the gearbox 11 together with the working tool 7 are rotated about the supporting tube section 9 that is on the motor side, and subsequently the clamping connection is again established. A further adjustment possibility is provided in the region of the shaft 17 that is on the tool side. The relative adjustment of the working tool from the position shown in FIG. 5 into the position shown in FIG. 6 can be achieved by releasing the clamping of the supporting tube section 10 in the shaft 17, rotating the working tool relative to the gearbox 11, and subsequently again establishing the clamping between the shaft 17 and the supporting tube section 10.

The miter gear 12 can also divide the supporting tube, or in the region of the drive motor can form the connection between the drive means and the supporting tube. In addition, as illustrated, the tool head is to be connected to the supporting tube via the miter gear. Depending upon need, a plurality of miter gears having the same or different angles can also be disposed over the length of the supporting tube.

The specification incorporates by reference the disclosure of German priority document 201 10 321.4 filed Jun. 21, 2001.

The present invention is, of course, in no way restricted to the specific disclosure of the specification and drawings, but also encompasses any modifications within the scope of the appended claims.

We claim:

1. A manually guided implement, comprising:
a supporting tube, at one end of which is held a working tool, and at another end of which is provided a drive motor for driving said working tool via a shaft that is disposed in said supporting tube, wherein said supporting tube has a first section that is associated with said drive motor, and a second section that is associated with said working tool; and
a miter gear having a gearbox for fixedly interconnecting said first and second sections of said supporting tube at an angle that is prescribed by said gearbox and is other than 180°.

2. An implement according to claim 1, wherein said gearbox has at least one shaft, and wherein at least one end of said sections of said supporting tube that face said gearbox extend into said at least one shaft of said gearbox.

3. An implement according to claim 2, wherein said gearbox is provided with two shafts and wherein ends of both of said sections of said supporting tube that face said gearbox extend into a respective one of said shafts of said gearbox.

4. An implement according to claim 3, wherein said shafts are monolithically formed with said gearbox.

5. An implement according to claim 2, wherein said gearbox has a spherical shape.

6. An implement according to claim 2, wherein said gearbox is formed of two housing portions.

7. An implement according to claim 6, wherein said housing portions are symmetrical relative to one another.

8. An implement according to claim 7, wherein said gearbox is divided along a centerline thereof.

9. An implement according to claim 2, wherein ends of sections of said shaft extend into said gearbox and are drivingly interconnected via bevel gears.

10. An implement according to claim 2, wherein ends of sections of said shaft extend into said gearbox and are drivingly interconnected via at least one universal coupling or a flexible shaft.

11. An implement according to claim 2, wherein ends of sections of said shaft that face said gearbox are held in said at least one shaft via at least one bearing means.

12. An implement according to claim 9, wherein said sections of said shaft have different speeds.

13. An implement according to claim 11, wherein said sections of said shaft have different speeds.

14. An implement according to claim 12, wherein proceeding from said drive motor, said miter gear transfers torque to said working tool in a slow or rapid manner in a ratio of 1.9:2.1.

15. An implement according to claim 13, wherein proceeding from said drive motor, said miter gear transfers torque to said working tool in a slow or rapid manner in a ratio of 1.9:2.1.

16. An implement according to claim 11, wherein said ends of said sections of said shaft that face said gearbox are fixedly and axially detachably connected with a respective hub and wherein said hubs are held in said at least one shaft with a respective one of said bearing means.

17. An implement according to claim 3, wherein said sections of said supporting tube are detachably and rotatably held in said shafts.

18. An implement according to claim 11, wherein a coordination of said sections of said supporting tube relative to said shaft is exchangeable.

19. An implement according to claim 3, wherein a coordination of said sections of said supporting tube relative to said shaft determines the speed or gear ratio of said miter gear.

20. An implement according to claim 6, wherein fastening means are provided for interconnecting said housing portions.

21. An implement according to claim 3, wherein said angle is approximately 150°.
